(19) United States
(12) Patent Application Publication
(10) Pub. No.: US 2010/0265580 A1
(43) Pub. Date: Oct. 21, 2010

(54) COATING COMPOSITION FOR ANTIREFLECTION, ANTIREFLECTION FILM AND METHOD FOR PREPARING THE SAME

(76) Inventors: Hansik Yun, Daejeon Metropolitan City (KR); Hyemin Kim, Daejeon Metropolitan City (KR); Boo Kyang Kim, Daejeon Metropolitan City (KR); Yeong-Rae Chang, Daejeon Metropolitan City (KR)

Correspondence Address: MCKENNA LONG & ALDRIDGE LLP, 1900 K STREET, NW, WASHINGTON, DC, 20006, US

(21) Appl. No.: 12/742,611

(22) PCT Filed: Nov. 13, 2008
(86) PCT No.: PCT/KR2008/006703

§ 371 Date: May 12, 2010

(30) Foreign Application Priority Data
Nov. 13, 2007 (KR) 10-2007-0115329
Nov. 13, 2007 (KR) 10-2007-0775348
Nov. 14, 2007 (KR) 10-2007-0115967
Apr. 18, 2008 (KR) 10-2008-0035891

(51) Int. Cl. G02B 5/30; F21V 9/06; B05D 3/10; C08F 2/48; B32B 27/08

(52) U.S. Cl. 359/485; 252/589; 427/385.5; 427/508; 428/447

(57) ABSTRACT

The present invention provides a coating composition for antireflection that includes a low refractive material having a refractive index of 1.2 to 1.45 and a high refractive resin having a refractive index of 1.46 to 2, in which the difference in the surface energy between two materials is 5 mN/m or more; an antireflection film manufactured using the coating composition for antireflection; and a method of manufacturing the antireflection film. According to the present invention, the antireflection film having excellent abrasion resistance and antireflection characteristic can be manufactured using a single composition by one coating process, thereby reducing manufacturing cost.

### TECHNICAL FIELD

The present invention relates to a coating composition for antireflection, an antireflection film manufactured using the coating composition for antireflection, and a method of manufacturing the antireflection film. More particularly, the present invention relates to a coating composition for antireflection, in which although a single coating composition containing resins that have a refractive index different from each other is used to form a single coating layer by one coating process, phase separation occurs on the single coating layer, thereby providing antireflection characteristic and abrasion resistance simultaneously; an antireflection film manufactured using the coating composition for antireflection; and a method of manufacturing the antireflection film.

This application claims priority from Korean Patent Application Nos. 10-2007-0115348 and 10-2007-0115329 filed on Nov. 13, 2007, Korean Patent Application No. 10-2007-0115967 filed on Nov. 14, 2007, and Korean Patent Application No. 10-2008-0035891 filed on Apr. 18, 2008 in the Korean Intellectual Property Office, the disclosure of which is incorporated herein by reference in its entirety.

### BACKGROUND ART

An object to perform a surface treatment on the surface of a display is to improve image contrast by improving the abrasion resistance of the display and decreasing the reflection of light emitted from an external light source. The decrease of the reflection of external light can be achieved by two methods. One method causes diffused reflection by using convexo-concave shape on the surface, and the other method causes destructive interference by using a multi-coating design.

Anti-glare coating using the convexo-concave shape on the surface has been generally used in the related art. However, there have been problems in that resolution deteriorates in a high-resolution display and the sharpness of an image deteriorates due to diffused reflection. In order to solve the above-mentioned problems, Japanese Patent Application Publication No. 11-138712 has disclosed a light-diffusion film where light is diffused in a film that is manufactured by using organic filler having a refractive index different from a binder. However, since there are problems in that luminance and contrast deteriorate, the light-diffusion film needs to be modified.

A method of causing the destructive interference of reflected light by a multi-coating design has been disclosed in Japanese Patent Application Publication Nos. 02-234101 and 06-18704. According to this method, it is possible to obtain antireflection characteristic without the distortion of an image. In this case, light reflected from layers should have phase difference in order to allow reflected light to destructively interfere, and a waveform of reflected light should have amplitude so that reflectance can be minimized reflectance during the destructive interference. For example, when an incidence angle with respect to a single antireflection coating layer provided on the substrate is 0°, the following expressions can be obtained.

nₒnₛ=n₁²

2n₁d₁=(m+½)λ(m=0, 1, 2, 3 . . . ) [Math Equation 1]

(nₒ: the refractive index of air, nₛ: the refractive index of a substrate, n₁: the refractive index of a film, d₁: the thickness of the film, λ: the wavelength of incident light)

In general, if the refractive index of the antireflection coating layer is smaller than the refractive index of the substrate, antireflection is effective. However, in consideration of the abrasion resistance of the coating layer, it is preferable that the refractive index of the antireflection coating layer is 1.3 to 1.5 times of the refractive index of the substrate. In this case, the reflectance is smaller than 3%. However, when an antireflection coating layer is formed on a plastic film, it is not possible to satisfy the abrasion resistance of a display. For this reason, a hard coating layer of several microns needs to be provided below the antireflection coating layer. That is, the antireflection coating layer using the destructive interference includes a hard coating layer for reinforcing abrasion resistance, and one to four antireflection coating layers that are formed on the hard coating layer. Accordingly, the multi-coating method obtains antireflection characteristic without the distortion of an image. However, there is still a problem in that manufacturing cost is increased due to the multi-coating.

A method of allowing reflected light to destructively interfere by a single coating design has been proposed in recent years. The following method has been disclosed in Japanese Patent Application Publication No. 07-168006. According to the method, ultrafine particle-dispersed liquid is applied on a substrate, and the spherical shapes of fine particles are exposed to the surface so that the difference in refractive index is gradually generated between air (interface) and the particle. As a result, it is possible to obtain antireflection characteristic. However, since the shape and size of the ultrafine particles should be uniform and these particles should be uniformly distributed on the substrate, it is difficult to achieve this method by general coating processes. Further, since the amount of a binder should be equal to or smaller than a predetermined amount in order to obtain a spherical shape on the surface of the film, there is a problem in that this method is very vulnerable to abrasion resistance. Further, since the coating thickness should be also smaller than the diameter of the fine particle, it is very difficult to obtain abrasion resistance.

### DISCLOSURE

### Technical Problem

In order to solve the above-mentioned problems, an object of the prevent invention is to provide a coating composition for antireflection, in which although the single coating composition is used to form a coating layer by one coating process, phase separation occurs on the coating layer to provide antireflection characteristic and abrasion resistance simultaneously, thereby improving process efficiency and reducing manufacturing cost; an antireflection film manufactured using the coating composition for antireflection; and a method of manufacturing the antireflection film.

### Technical Solution

In order to achieve the above-mentioned object, the present invention provides a coating composition for antireflection that includes a low refractive material having a refractive index of 1.2 to 1.45 and a high refractive resin having a refractive index of 1.46 to 2, in which the difference in the surface energy between two materials is 5 mN/m or more.

Further, the present invention provides a method of manufacturing an antireflection film, comprising the steps of

a) preparing a coating composition for antireflection that includes a low refractive material having a refractive index of 1.2 to 1.45 and a high refractive resin having a refractive index of 1.46 to 2, in which the difference in the surface energy between two materials is 5 mN/m or more;

b) applying the coating composition on a substrate to form a coating layer;

c) drying the coating layer to allow phase separation of the low and high refractive materials; and

d) curing the dried coating layer.

The coating composition for antireflection may further include a fluorinated compound or nanoparticle-dispersed liquid in order to facilitate phase separation of the low and high refractive materials.

Further, the present invention provides an antireflection film comprising a single coating layer that includes a low refractive material having a refractive index of 1.2 to 1.45 and a high refractive resin having a refractive index of 1.46 to 2, in which the difference in the surface energy between two materials is 5 mN/m or more and the low and high refractive materials have a concentration gradient in a thickness direction.

Further, the present invention provides a polarizing plate, comprising a) a polarizing film, and b) the antireflection film according to the prevent invention that is provided on at least one side of the polarizing film.

Furthermore, the present invention provides a display device, comprising the antireflection film or the polarizing plate.

### ADVANTAGEOUS EFFECTS

By using the above-mentioned coating composition for antireflection and the method of manufacturing the antireflection film, the present invention can provide an antireflection film including an antireflection layer that has excellent antireflection characteristic and abrasion resistance, in which the antireflection layer is composed of a singe coating layer. Since the antireflection film according to the present invention has excellent abrasion resistance and low refractive characteristic, and can be manufactured by one coating process, it is possible to improve process efficiency and reduce manufacturing cost.

### DESCRIPTION OF DRAWINGS

FIG. 1 is a transmission electron microscope image showing a cross-sectional view of the antireflection film according to Example 1.

### BEST MODE

Hereinafter, the present invention will be described in detail.

The coating composition for antireflection according to the present invention is characterized in that it includes a low refractive material having a refractive index of 1.2 to 1.45 and a high refractive resin having a refractive index of 1.46 to 2, and the difference in the surface energy between two materials is 5 mN/m or more. Phase separation may occur due to the difference in the surface energy between the low and high refractive materials by using the coating composition for antireflection during coating, drying and curing processes. Therefore, excellent antireflection characteristic and abrasion resistance can be provided, even though one coating process is performed using a single composition.

In the present invention, the surface energy is measured in cured products that are produced by curing the materials.

After completing the coating process, the low refractive material gradually moves toward the upper portion of the coating layer due to the difference in the surface energy between the low and high refractive materials, and the high refractive material is located in the lower portion of the coating layer. In order to maximize the phase separation and fix the position of the phase separation during drying and curing steps, it is preferable that the low refractive material is a thermosetting material that is flexible at room temperature and gradually cured according to temperature. In addition, the low refractive material preferably has a surface energy of 25 mN/m or less, and more preferably 5 mN/m to 25 mN/m.

In the present invention, it is preferable that the low refractive material is contained in an amount of 5 to 80 parts by weight, and the high refractive material is contained in an amount of 10 to 90 parts by weight, based on 100 parts by weight of the total coating composition.

The low refractive-thermosetting material is a thermosetting material that has a refractive index in the range of 1.2 to 1.45. For example, an alkoxysilane reactant that may cause a sol-gel reaction, a urethane reactive group compound, a urea reactive group compound, an esterification reactant or the like may be used as the low refractive-thermosetting resin.

The alkoxysilane reactant is a reactive oligomer that is manufactured by performing hydrolysis and a condensation reaction of alkoxysilane, fluorinated alkoxysilane, silane-based organic substituents under the conditions of water and a catalyst through a sol-gel reaction. The sol-gel reaction may adopt any method commonly used in the art. The sol-gel reaction is conducted at a reaction temperature of 0 to 150° C. for 1 to 70 hours, including alkoxysilane, fluorinated alkoxysilane, catalyst, water and organic solvent. In this case, when being measured by GPC (Gel Permeation Chromatography) while polystyrene is used as a reference material, the average molecular weight of the reactive oligomer, alkoxysilane is preferably in the range of 1,000 to 200,000. A condensation reaction is performed at a temperature equal to or higher than room temperature after coating, so that the alkoxysilane reactant manufactured as described above forms a net having the cross-linking structure.

The alkoxysilane can give strength to a level required in an outermost thin film. In particular, the alkoxysilane may adopt tetraalkoxysilanes or trialkoxysilanes. Meanwhile, the alkoxysilane is preferably at least one selected from the group consisting of tetramethoxy silane, tetraethoxy silane, tetraisopropoxysilane, methyltrimethoxysilane, methyltriethoxysilane, glycycloxy propyl trimethoxysilane, and glycycloxy propyl triethoxysilane, but is not limited thereto.

The basic monomer alkoxysilane is preferably contained in an amount of 5 to 50 parts by weight, based on the 100 parts by weight of the alkoxysilane reactant. If the content is less than 5 parts by weight, it is difficult to obtain excellent abrasion resistance. If the content is more than 50 parts by weight, it is difficult to achieve low refractive characteristic of the alkoxysilane reactant and phase separation from the high refractive material.

The fluorinated alkoxysilane lowers the refractive index and surface tension of the coating thin film to facilitate the phase separation from the high refractive material. The fluorinated alkoxysilane is preferably a low refractive material having low refractive index of 1.3 to 1.4 and low surface tension of 10 to 15 mN/m. The fluorinated alkoxysilane is preferably one or more selected from the group consisting of tridecafluorooctyltriethoxysilane, heptadecafluorodecyltrimethoxysilane, and heptadecafluorodecyltriisopropoxysilane, but is not limited thereto.

In order to allow the alkoxysilane reactant to have the refractive index of 1.2 to 1.45 and facilitate phase separation from the high refractive material, the content of the fluorinated alkoxysilane is preferably 10 to 70 parts by weight, based on 100 parts by weight of the alkoxysilane reactant. If the content is less than 10 parts by weight, it is difficult to achieve low refractive characteristic and phase separation from the high refractive material. If the content is more than 70 parts by weight, it is difficult to ensure the stability and scratch resistance of the solution.

The silane-based organic substituent can chemically bind with alkoxysilane, form a double bond with the high refractive material to improve compatibility of low and high refractive materials, and improve adherence of alkoxysilane and the high refractive material after phase separation. Thus, any compound may be used without limitation, as long as it has the above functions. The silane-based organic substituent is preferably one or more selected from the group consisting of vinyl trimethoxy silane, vinyl tri(beta-methoxyethoxy)silane, vinyl triethoxy silane, vinyl tri-n-propoxy silane, vinyl tri-n-pentoxy silane, vinylmethyl dimethoxy silane, diphenyl ethoxy vinylsilane, vinyl triisopropoxy silane, divinyl di(beta-methoxyethoxy)silane, divinyl dimethoxy silane, divinyl diethoxy silane, divinyl di-n-propoxy silane, divinyl di(isopropoxy)silane, divinyl di-n-pentoxy silane, 3-acryloxypropyl trimethoxy silane, 3-methacryloxypropyl trimethoxy silane, gamma-methacryloxypropyl methyl diethoxy silane, gamma-methacryloxypropyl methyl diethoxysilane, but is not limited thereto.

In order to maintain compatibility and stability of the alkoxysilane reactant in the coating solution, the content of the silane-based organic substituent is preferably 0 to 50 parts by weight, based on 100 parts by weight of the alkoxysilane reactant. If the content is more than 50 parts by weight, it is difficult to achieve low refractive characteristic and phase separation from the high refractive material. In addition, if the silane-based organic substituent is not added thereto, the compatibility of the low refractive material for the high refractive material is not sufficient, and thus the coating solution may not be mixed well.

The catalyst to be used in the sol-gel reaction is an ingredient that is required for controlling the sol-gel reaction time. The catalyst is preferably an acid such as nitric acid, hydrochloric acid, sulfuric acid, and acetic acid, and more preferably hydrochloride, nitrate, sulfate, or acetate of zirconium or indium, but is not limited thereto. In this connection, the catalyst is preferably used in the amount of 0.1 to 10 parts by weight, based on 100 parts by weight of the alkoxysilane reactant.

The water to be used in the sol-gel reaction is required for hydrolysis and condensation, and is used in the amount of 5 to 50 parts by weight, based on 100 parts by weight of the alkoxysilane reactant.

The organic solvent to be used in the sol-gel reaction is an ingredient to control a molecular weight of hydrolysis condensate. The organic solvent is preferably a single solvent or a mixed solvent selected from the group consisting of alcohols, cellosolves and ketones. In this connection, the organic solvent is preferably contained in an amount of 0.1 to 50 parts by weight, based on 100 parts by weight of the alkoxysilane reactant.

Meanwhile, the urethane reactive group compound may be manufactured by the reaction between alcohol and an isocyanate compound while a metal catalyst is used. If a solution including a metal catalyst, multifunctional isocyanate, and multifunctional alcohol having two or more functional groups is maintained at a temperature equal to or higher than room temperature, it is possible to form the net structure including a urethane reactive group. In this case, a fluorine group may be introduced in the alcohol or the isocyanate, in order to achieve low refractive characteristic and induce phase separation from the high refractive material.

Examples of the multifunctional alcohol containing fluorine may include 1H,1H,4H,4H-perfluoro-1,4-butanediol, 1H,1H,5H,5H-perfluoro-1,5-pentanediol, 1H,1H,6H,6H-perfluoro-1,6-hexanediol, 1H,1H,8H,8H-perfluoro-1,8-octanediol, 1H,1H,9H,9H-perfluoro-1,9-nonanediol, 1H,1H,10H,10H-perfluoro-1,10-decanediol, 1H,1H,12H,12H-perfluoro-1,12-dodecanediol, fluorinated triethylene glycol, and fluorinated tetraethylene glycol, but are not limited thereto.

Aliphatic isocyanate, cycloaliphatic isocyanate, aromatic isocyanate, or heterocyclic isocyanate may be preferably used as an isocyanate ingredient that is used to manufacture the urethane reactive group compound. Specifically, diisocyanate, such as hexamethylene diisocyanate, 1,3,3-trimethylhexamethylene diisocyanate, isophorone diisocyanate, toluene-2,6-diisocyanate, and 4,4′-dicyclohexane diisocyanate, or three or more functional isocyanate, for example, DN950 and DN980 (trade name) manufactured by DIC corporation may be preferably used as the isocyanate ingredient.

In the present invention, a catalyst may be used to manufacture the urethane reactive group compound. A Lewis acid or a Lewis base may be used as the catalyst. Specific examples of the catalyst may include tin octylate, dibutyltin diacetate, dibutyltin dilaurate, dibutyltin mercaptide, dibutyltin dimaleate, dimethyltin hydroxide, and triethylamine, but are not limited thereto.

The content of the isocyanate and the multifunctional alcohol, which are used to manufacture the urethane reactive group compound, is preferably set so that the molar ratio (NCO/OH) of the functional groups, a NCO group and an OH group is preferably in the range of 0.5 to 2, and more preferably in the range of 0.75 to 1.1. If the mole ratio of the functional groups is less than 0.5 or exceeds 2, the unreacted functional groups are increased. As a result, there may be a problem in that the strength of the film deteriorates.

The urea reactive group compound may be manufactured by the react ion between amine and isocyanates. The manufacture of the urea reactive group compound may employ isocyanates, which is the same as the isocyanates used to manufacture the urethane reactive group compound. Two or more functional perfluoro amines may be used as the amines. If necessary, a catalyst may be used in the present invention. A Lewis acid or a Lewis base may be used as the catalyst. Specific examples of the catalyst may include tin octylate, dibutyltin diacetate, dibutyltin dilaurate, dibutyltin mercaptide, dibutyltin dimaleate, dimethyltin hydroxide, and triethylamine, but are not limited thereto.

The esterification reactant may be obtained by the dehydration and condensation reaction between an acid and alcohol. If the esterification reactant is also mixed in the coating composition, it is possible to form a film having the cross-linking structure. It is preferable that two or more functional acids including fluorine are used as the acid. Specific examples thereof may include perfluorosucinic acid, perfluoroglutaric acid, perfluoroadipic acid, perfluorosuberic acid, perfluoroazelaic acid, perfluorosebacic acid, and perfluorolauric acid. The multifunctional alcohol is preferably used as the alcohol. Examples of the multifunctional alcohol include 1,4-butanediol, 1,2-butanediol, 1,5-pentanediol, 2,4-pentanediol, 1,4-cyclohexanediol, 1,6-hexanediol, 2,5-hexanediol, 2,4-heptanediol, pentaerythritol, and trimethylolpropane, but are not limited thereto. An acid catalyst such as a sulphuric acid or alkoxytitan such as tetrabutoxytitan may be used in the esterification reaction. However, the material used in the esterification reaction is not limited to the above-mentioned material.

The high refractive material is a resin having a refractive index of 1.45 to 2, which is relatively higher than that of the low refractive material, and the difference in the surface energy between the cured products of high and low refractive materials is 5 mN/m or more. It is preferable that the cured product of the high refractive material has the surface energy of 5 mN/m or higher than that of the low refractive material.

The high refractive material is preferably a high refractive ultraviolet curable resin. The materials for the high refractive ultraviolet curable resin may include an acrylate resin, a photoinitiator and a solvent, if necessary, a surfactant. Examples of the acrylate resin may include acrylate monomer, urethane acrylate oligomer, epoxy acrylate oligomer, and ester acrylate oligomer. The ultraviolet curable resin may contain a substituent, such as sulfur, chlorine, and metal, or an aromatic material in order to obtain a high refractive index. Examples thereof may include dipentaerythritol hexaacrylate, pentaerythritol tri/tetra acrylate, trimethylene propane triacrylate, ethylene glycol diacrylate, 9,9-bis(4-(2-acryloxy ethoxy phenyl)fluorine (refractive index: 1.62), bis(4-methacryloxythiophenyl)sulphide (refractive index: 1.689), and bis(4-vinylthiophenyl)sulphide (refractive index: 1.695). The mixture of one or two or more thereof may be used.

The content of the acrylate resin is preferably 10 to 80 parts by weight, based on 100 parts by weight of the high refractive material. If the content is less than 10 parts by weight, there are problems in that scratch resistance and abrasion resistance of the coating film may deteriorate, and viscosity of the coating solution may be significantly reduced not to transfer to a coating machine and substrate. If the content is more than 80 parts by weight, it is difficult to achieve phase separation from the low refractive material due to high viscosity of the coating solution, and there is a problem in that flatness and coating nature of the coating film may deteriorate.

The photoinitiator is preferably a compound degradable by UV, and examples thereof may include 1-hydroxy cyclohexyl phenyl ketone, benzyl dimethyl ketal, hydroxy dimethyl acetophenone, benzoin, benzoin methyl ether, benzoin ethyl ether, benzoin isopropyl ether, and benzoin butyl ether.

The photoinitiator is preferably used in an amount of 1 to 20 parts by weight, based on 100 parts by weight of the high refractive material. If the content is less than 1 part by weight, proper curing may not occur. If the content is more than 20 parts by weight, scratch resistance and abrasion resistance of the coating film may deteriorate.

Examples of the solvent may include alcohols, acetates, ketones, aromatic solvents or the like. Specific examples of the solvent may include methanol, ethanol, isopropyl alcohol, butanol, 2-methoxy ethanol, 2-ethoxy ethanol, 2-butoxy ethanol, 2-isopropoxy ethanol, methyl acetate, ethyl acetate, butyl acetate, methyl ethyl ketone, methyl isobutyl ketone, cyclohexane, cyclohexanone, toluene, xylene, and benzene, but are not limited thereto.

The solvent is preferably used in an amount of 10 to 90 parts by weight, based on 100 parts by weight of the high refractive material. If the content is less than 10 parts by weight, it is difficult to achieve phase separation from the low refractive material due to high viscosity of the coating solution, and there is a problem in that flatness of the coating film may deteriorate. If the content is more than 90 parts by weight, there are problems in that scratch resistance and abrasion resistance of the coating film may deteriorate, and viscosity of the coating solution may be significantly reduced not to transfer to a coating machine and substrate.

The high refractive ultraviolet curable resin may further include a surfactant. Example of the surfactant may include a levelling agent or a wetting agent, in particular, fluorine compounds or polysiloxane compounds, but is not limited thereto.

The surfactant is preferably used in an amount of 5 parts by weight, based on 100 parts by weight of the high refractive material. If the content is more than 5 parts by weight, it is difficult to achieve phase separation from the low refractive material, and there are problems in that adherence to the substrate, scratch resistance and abrasion resistance of the coating film may deteriorate. The surfactant is preferably added in an amount of 0.05 or more parts by weight, based on 100 parts by weight of the high refractive material, in order to obtain its sufficient effect.

After completing the drying and curing process, the difference in the refractive indices of the cured products of the above mentioned low and high refractive materials is preferably 0.01 or more. In this case, the single coating layer functionally forms a GRIN (gradient refractive index) structure consisting of two or more layers, so as to obtain an antireflection effect. In this connection, when the cured low refractive material has the surface energy of 25 mN/m or less, and the difference in the surface energy between low and high refractive materials is 5 mN/m or more, phase separation occurs effectively.

The coating composition for antireflection according to the present invention may further include at least one of a fluorinated compound and nanoparticle-dispersed liquid in order to facilitate phase separation of the low and high refractive materials.

It is preferable that the fluorinated compound has a refractive index of 1.5 or less, a molecular weight being smaller than that of the low refractive material, and a surface energy between those of high and low refractive materials. The fluorinated compound is preferably contained in an amount of 0.05 to 72 parts by weight, based on 100 parts by weight of the total coating composition.

The fluorinated compound is the low refractive-thermosetting resin such as fluorinated alkoxysilane, fluorinated alcohol, fluorinated isocyanate, fluorinated amines, and two or more functional acids containing fluorine, and preferably one or more materials selected from the group consisting of the exemplified fluorinated compounds, one or more fluorinated acrylates further having a C₁-C₆ straight or branched chain hydrocarbon group as a substituent, which are represented by the following Formulae I to 5, various fluorinated additives such as a levelling agent, a dispersing agent, a surface-modification agent, a wetting agent, a defoamer, and a compatibilizer, which contain fluorine, and fluorinated solvents.

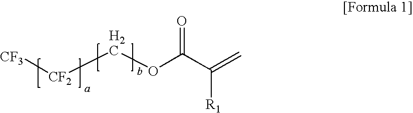

wherein R₁ is —H or C₁-C₆ hydrocarbon, a is an integer of 0 to 4, and b is an integer of 1 to 3. The C₁-C₆ hydrocarbon group is preferably a methyl group (—CH₃).

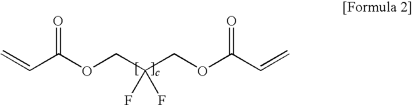

wherein c is an integer of 1 to 10.

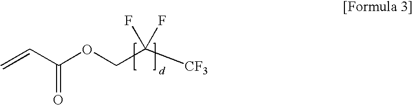

wherein d is an integer of 1 to 9.

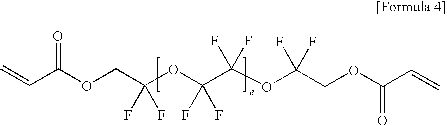

wherein e is an integer of 1 to 5.

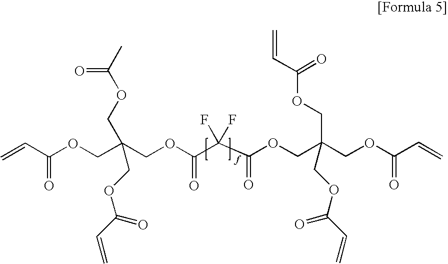

Wherein f is an integer of 4 to 10.

The fluorinated compound is preferably used in the range of keeping low refractive characteristic of the coating film, strength of the coating film and adherence to a display substrate, in particular, in an amount of 1 to 90 parts by weight, based on 100 parts by weight of the low refractive material.

It is preferable that the nanoparticle-dispersed liquid contains nanoparticles having an average particle size of 1,000 nm or less, preferably 1 to 200 nm or less, and more preferably 2 to 100 nm, in order to obtain a visible light scattering or diffusion-free transparent film. The nanoparticle-dispersed liquid preferably has a refractive index of 1.45 or less. The nanoparticle-dispersed liquid may further include a dispersion-enhancing chelating agent, a fluorinated acrylate, a solvent or the like. The nanoparticle-dispersed liquid is preferably contained in an amount of 2 to 27 parts by weight, based on 100 parts by weight of the total coating composition.

The nanoparticle may be metal fluoride, other organic/inorganic hollow and porous particles. In particular, metal fluoride is a particle having an average particle size of 10 to 100 nm, and includes one or more selected from the group consisting of NaF, LiF, AlF₃, Na₅Al₃F₁₄, Na₃AlF₆, MgF₂, NaMgF₃ and YF₃.

The nanoparticle is preferably used in the range of keeping low refractive characteristic of the coating film, strength of the coating film and adherence to a display substrate. The nanoparticle is preferably contained in an amount of 5 parts by weight to 70 parts by weight, based on 100 parts by weight of the nanoparticle-dispersed liquid.

The dispersion-enhancing chelating agent is a liquid component used for endowing compatibility between the high and low refractive materials and nanoparticles such that the nanoparticles does not easily lump, and also preventing the coating film from being misty. The dispersion-enhancing chelating agent may be added, if necessary. The dispersion-enhancing chelating agent preferably adopts one or more materials selected from the group consisting of Mg(CF₃COO)₂, Na(CF₃COO), K(CF₃COO), Ca(CF₃COO)₂, Mg(CF₂COCHCOCF₃)₂, Na(CF₂COCHCOCF₃), Zr(AcAc), Zn(AcAC), Ti(AcAc), and Al(AcAc), wherein AcAc is acetyl acetone.

In addition, the solvent may be preferably DAA, AcAc, and cellosolves, but is not limited thereto.

The dispersion-enhancing chelating agent is preferably used in the range of keeping dispersion of nanoparticles, strength of the coating film, and adherence to a display substrate. Specifically, the dispersion-enhancing chelating agent is preferably used in an amount of 10 to 80 parts by weight, based on 100 parts by weight of the nanoparticle-dispersed liquid.

The fluorinated acrylate is used for endowing compatibility with the high and low refractive materials and film strength by chemical bonding, and may be one or more materials selected from the group consisting of the compounds that are represented by Formulae I to 5 and further contain a C₁-C₆ hydrocarbon group as a substituent. The fluorinated acrylate is preferably used in an amount of 80 parts by weight or less, based on 100 parts by weight of the nanoparticle-dispersed liquid.

Examples of the solvent for the nanoparticle-dispersed liquid may include alcohols, acetates, ketones, or aromatic solvents, in particular, methanol, ethanol, isopropyl alcohol, butanol, 2-methoxy ethanol, 2-ethoxy ethanol, 2-butoxy ethanol, 2-isopropoxy ethanol, methyl acetate, ethyl acetate, butyl acetate, methyl ethyl ketone, methyl isobutyl ketone, cyclohexane, cyclohexanone, toluene, xylene, benzene or the like. The solvent is preferably used in an amount of 10 to 90 parts by weight, based on 100 parts by weight of the nanoparticle-dispersed liquid.

The present invention provides an antireflection film manufactured by using the above-mentioned coating composition for antireflection, and a method of manufacturing the same.

The method of manufacturing an antireflection film according to the present invention comprises the steps of

a) preparing the above-mentioned coating composition for antireflection;

b) applying the coating composition on a substrate to form a coating layer;

c) drying the coating layer to allow phase separation of the low and high refractive materials; and

d) curing the dried coating layer.

In step b), the substrate may be glass, plastic sheet and film, and its thickness is not limited. Examples of the plastic film may include a triacetate cellulose film, a norbornene cycloolefin polymer, a polyester film, a poly methacrylate film, and a polycarbonate film, but are not limited thereto.

In step b), the method of applying the coating composition may adopt various methods such as bar coating, two-roll or three-roll reverse coating, gravure coating, die coating, micro gravure coating, and comma coating, which may be selected depending on types of the substrate and liquid phase or rheological properties of the coating solution without any restriction.

The coating thickness is not specifically limited, but preferably in the range of 0.5 to 30 μm, and a drying process for drying a solvent is performed after the coating process. After the drying process, if the coating thickness is less than 0.5 μm, the abrasion resistance is not sufficiently improved. If the coating thickness is more than 30 μm, it is difficult to achieve phase separation of the low and high refractive materials, so as not to obtain a desirable refractive characteristic.

In step c), the drying process may be performed at a temperature of 40 to 150° C. for 0.1 to 30 min in order to remove the organic solvent from the coating composition and gradually cure the low refractive material in the upper portion of the coating layer. If the temperature is less than 40° C., the organic solvent is not completely removed to deteriorate the degree of cure upon UV curing. If the temperature is more than 150° C., the curing may occur before the low refractive material positions in the upper portion of the coating layer.

In step d), the curing process may be performed by UV or heat depending on types of the used resin. In the case of using both thermosetting and UV curable resins, the UV curing process is first performed, followed by heat curing process.

The UV curing process may be performed at UV radiation dose of 0.01 to 2 J/cm² for 1 to 600 sec to provide the coating layer with sufficient abrasion resistance. If the UV radiation dose is not within the above range, an uncured resin remains on the coating layer, and thus the surface becomes sticky not to ensure abrasion resistance. If the UV radiation dose exceeds the above range, the degree of the UV curable resin is too increased, and thus the curing of the thermosetting resin may be prevented in the heat curing step.

The heat curing may be performed at a temperature of 20 to 200° C. for 1 to 72 hrs. If the temperature is less than 20° C., the curing rate is too low to reduce the curing time. If the temperature is more than 200° C., there is a problem in stability of the coating substrate. The curing process is preferably performed for 1 to 72 hrs, and in order to maximize the scratch resistance of the coating layer, the thermosetting resin should be sufficiently cured.

The antireflection film according to the present invention, prepared by using the above-mentioned coating composition for antireflection, comprises a single coating layer that includes a low refractive resin having a refractive index of 1.2 to 1.45 and a high refractive material having a refractive index of 1.46 to 2, preferably further includes at least one of the fluorinated compound and nanoparticle-dispersed liquid, in which the difference in the surface energy between two materials is 5 mN/m or more and the low and high refractive materials have has a concentration gradient in a thickness direction. The antireflection film may further include a substrate provided on one side of the coating layer.

In the antireflection film, the low refractive material, which is included in a region corresponding to 50% in a thickness direction from the surface of the coating layer facing air, is preferably 70% or more, more preferably 85% or more, and most preferably 95% or more, based on the total weight of the low refractive material. The antireflection film according to the present invention has a reflectance of less than 3% to exhibit the excellent antireflection effect.

In addition, the present invention provides a polarizing plate comprising the above-mentioned antireflection film according to the prevent invention. In particular, the polarizing plate according to the present invention comprises a) a polarizing film, and b) the antireflection film according to the prevent invention that is provided on at least one side of the polarizing film. A protection film may be provided between the polarizing film and the antireflection film. In addition, the substrate, which is used to form the single coating layer during the manufacture of the antireflection film, may be used as the protection film, as it is. The polarizing film and the antireflection film may be combined with each other by an adhesive. The polarizing film known in the art may be used.

The present invention provides a display device that includes the antireflection film or the polarizing plate. The display device may be a liquid crystal display or a plasma display. The display device according to the present invention may have the structure known in the art, except for the fact that the antireflection film according to the present invention is provided. For example, in the display device according to the present invention, the antireflection film may be provided on the outermost surface of a display panel facing an observer or on the outermost surface thereof facing a backlight. Further, the display device according to the present invention may include a display panel, a polarizing film that is provided on at least one side of the panel, and an antireflection film that is provided on the side opposite to the side of the polarizing film facing the panel.

### MODE FOR INVENTION

Hereinafter, the preferred Examples are provided for better understanding. However, these Examples are for illustrative purposes only, and the invention is not intended to be limited by these Examples.

### EXAMPLE

### Preparative Example

### Preparation of Low Refractive-Thermosetting Material

### Material A

15.3 parts by weight of DN 980 (manufactured by DIC corporation) in which the average number of isocyanate functional groups is three, 14 parts by weight of two functional alcohol 1H,1H,12H,12H-perfluoro-1,12-dodecanediol including fluorine, 0.7 parts by weight of dibutyltin dilaurate as a metal catalyst, and 35 parts by weight of each of diacetone alcohol (DAA) and methyl ethyl ketone (MEK) as a solvent were uniformly mixed to prepare a low refractive-thermosetting solution.

<Preparation of Low Refractive-Thermosetting Material (Material B)>

A mixture of 10 parts by weight of tetraethoxysilane, 30 parts by weight of heptadecafluorodecyltrimethoxysilane, 20 parts by weight of methacryl trimethoxysilane, 10 parts by weight of water, 0.5 parts by weight of hydrochloric acid, 40 parts by weight of ethanol, and 40 parts by weight of 2-butanol was subjected to sol-gel reaction at room temperature for 12 hrs to prepare a low refractive-thermosetting solution.

<Preparation of Low Refractive-Thermosetting Material (Material C)>

A mixture of 25 parts by weight of fluoroalkylmethoxysilane, 20 parts by weight of tetraethoxysilane, 7 parts by weight of 3-methacryloxypropyl trimethoxy silane, 7.5 parts by weight of water, 0.5 parts by weight of nitric acid, 20 parts by weight of methanol, and 20 parts by weight of 2-butyl alcohol was subjected to sol-gel reaction at room temperature for 24 hrs to prepare a low refractive-thermosetting solution.

<Preparation of Low Refractive-Thermosetting Material (Material D)>

A mixture of 15 parts by weight of fluoroalkylmethoxysilane, 25 parts by weight of tetraethoxysilane, 12 parts by weight of 3-methacryloxypropyl trimethoxy silane, 7.5 parts by weight of water, 0.5 parts by weight of nitric acid, 20 parts by weight of methanol, and 20 parts by weight of 2-butyl alcohol was subjected to sol-gel reaction at room temperature for 24 hrs to prepare a low refractive-thermosetting solution.

<Preparation of High Refractive-UV Curable Material (Material E)>

28 parts by weight of dipentaerythritol hexaacrylate (DPHA) as multifunctional acrylate for improving the strength of a coating film, 2 parts by weight of Darocur 1173 as an UV initiator, and 35 parts by weight of each of diacetone alcohol (DAA) and methyl ethyl ketone (MEK) as a solvent were uniformly mixed to prepare a high refractive-UV curable solution.

<Preparation of High Refractive-UV Curable Material (Material F)>

30 parts by weight of dipentaerythritol hexaacrylate (DPHA) as multifunctional acrylate for improving the strength of a coating film, 1 part by weight of Darocur 1173 as an UV initiator, 20 parts by weight of ethanol, 29 parts by weight of n-butyl alcohol, and 20 parts by weight of acetylacetone (AcAc) as a solvent were uniformly mixed to prepare a high refractive-UV curable solution.

<Preparation of Low Refractive-Thermosetting Material (Material G)>

A mixture of 5 parts by weight of fluoroalkylethoxysilane, 37 parts by weight of tetramethoxysilane, 10 parts by weight of vinyl trimethoxy silane, 7.5 parts by weight of water, 0.5 parts by weight of nitric acid, and 40 parts by weight of methanol was subjected to sol-gel reaction at room temperature for 24 hrs to prepare a low refractive-thermosetting solution.

<Preparation of High Refractive-UV Curable Material (Material H)>

20 parts by weight of pentaerythritol tri/tetra acrylate as multifunctional acrylate for improving the strength of a coating film, 10 parts by weight of trimethylenepropanetriacrylate, 1 part by weight of Darocur 1173 as an UV initiator, 5 parts by weight of BYK 333 and 4 parts by weight of BYK371 as a surfactant, 20 parts by weight of ethanol, 20 parts by weight of n-butyl alcohol, and 20 parts by weight of methyl ethyl ketone (MEK) as a solvent were uniformly mixed to prepare a high refractive-UV curable solution.

### Example 1

30 parts by weight of the low refractive-thermosetting material A and 70 parts by weight of the high refractive-UV curable material E were uniformly mixed to prepare a coating composition for antireflection.

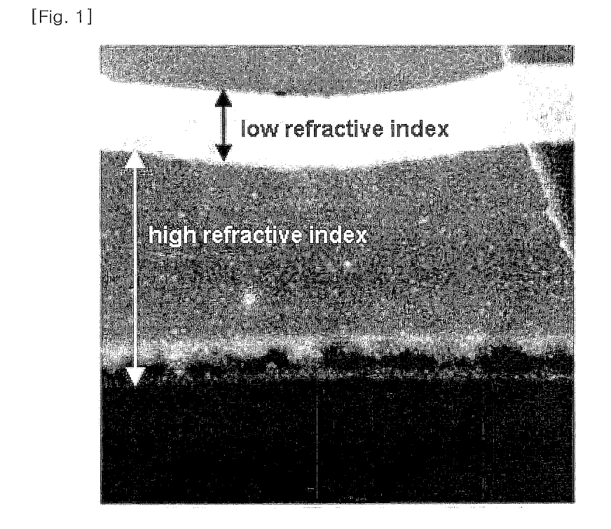

The prepared composition was applied to a triacetate cellulose film having a thickness of 80 an using a wire bar (No. 5). The film was dried in an oven at 60° C. for 2 min, and cured by UV radiation at a dose of 1 J/cm², followed by heat curing in the oven at 120° C. for a day. The final coating layer had a thickness of 1 μm, and its cross-section was observed under a transmission electron microscope, shown in FIG. 1.

With reference to FIG. 1, it was found that the high refractive material layer and the low refractive material layer were separately formed on the substrate in a layer structure. When the layer structure is formed by the materials having different refractive indices, more effective reflectance can be obtained, as compared to a monolayer structure.

### Example 2

A film was manufactured in the same manners as in Example 1, except using a material B instead of the material A as a low refractive-thermosetting material.

### Example 3

25 parts by weight of the low refractive-thermosetting material C and 75 parts by weight of the high refractive-UV curable material F were uniformly mixed to prepare a compatible mixed solution, resulting in a coating composition.

The prepared coating composition was applied to a triacetate cellulose film having a thickness of 80 μm using a wire bar (No. 5). The film was dried in an oven at 120° C. for 2 min, and cured by UV radiation at a dose of 200 mJ/cm², followed by heat curing in the oven at 120° C. for a day. The final coating layer had a thickness of 1 μm.

### Example 4

30 parts by weight of the low refractive-thermosetting material A and 70 parts by weight of the high refractive-UV curable material F were uniformly mixed to prepare a compatible coating composition. A coating film was manufactured using the composition in the same manner as in Example 3.

### Example 5

20 parts by weight of the low refractive-thermosetting material C, 75 parts by weight of the high refractive-UV curable material F, and 5 parts by weight of trifluoroethylacrylate as a fluorinated compound were uniformly mixed to prepare a compatible coating composition for antireflection. A coating film was manufactured using the composition in the same manner as in Example 3.

### Example 6

25 parts by weight of the low refractive-thermosetting material A, 70 parts by weight of the high refractive-UV curable material F, and 5 parts by weight of trifluoroethylacrylate as a fluorinated compound were uniformly mixed to prepare a compatible coating composition for antireflection. A coating film was manufactured using the composition in the same manner as in Example 3.

### Example 7

25 parts by weight of the low refractive-thermosetting material D, 70 parts by weight of the high refractive-UV curable material F, and 5 parts by weight of trifluoroethylacrylate as a fluorinated compound were uniformly mixed to prepare a compatible coating composition for antireflection. A coating film was manufactured using the composition in the same manner as in Example 3.

### Example 8

22 parts by weight of the low refractive-thermosetting material C, 70 parts by weight of the high refractive-UV curable material F, and 8 parts by weight of tridecafluorooctyltriethoxysilane as a fluorinated compound were uniformly mixed to prepare a compatible coating composition for antireflection. A coating film was manufactured using the composition in the same manner as in Example 3.

### Example 9

26 parts by weight of the low refractive-thermosetting material C, 70 parts by weight of the high refractive-UV curable material F, and 4 parts by weight of Fluorad FC4430 (3M) as a fluorinated compound were uniformly mixed to prepare a compatible coating composition for antireflection. A coating film was manufactured using the composition in the same manner as in Example 3.

### Example 10

50 parts by weight of 10% MgF₂-dispersed liquid, 30 parts by weight of magnesium trifluoroacetate, and 20 parts by weight of methylethylketone (MEK) were uniformly mixed to prepare a metal fluoride-dispersed liquid.

8 parts by weight of the low refractive-thermosetting material C, 75 parts by weight of the high refractive-UV curable material F, and 17 parts by weight of the metal fluoride-dispersed liquid were uniformly mixed to prepare a compatible coating composition for antireflection. A coating film was manufactured using the composition in the same manner as in Example 3.

### Example 11

A coating solution and a coating film were manufactured in the same manners as in Example 10, except using the material A instead of the material C as a low refractive-thermosetting material.

### Example 12

25 parts by weight of the low refractive-thermosetting material D, 70 parts by weight of the high refractive-UV curable material F, and 5 parts by weight of the metal fluoride-dispersed liquid prepared in Example 10 were uniformly mixed to prepare a compatible coating composition for antireflection. A coating film was manufactured using the composition in the same manner as in Example 3.

### Example 13

10 parts by weight of NaMgF₃ having an average particle size of 30-40 nm and 90 parts by weight of isopropyl alcohol (IPA) were uniformly mixed to prepare a metal fluoride-dispersed liquid. A coating solution and a coating film were manufactured in the same manners as in Example 10, except using the metal fluoride-dispersed liquid.

### Example 14

10 parts by weight of Meso-porous Silica having an average particle size of 20 nm and 20% porosity and 90 parts by weight of methanol were uniformly mixed to prepare a nanoparticle-dispersed liquid. A coating solution and a coating film were manufactured in the same manners as in Example 10, except using the nanoparticle-dispersed liquid.

### Comparative Example 1

The high refractive-UV curable material E was only used as a material for the formation of a coating layer, and applied to a triacetate cellulose film having a thickness of 80 μm using a wire bar (No. 5). The film was dried in an oven at 60° C. for 2 min, and cured by UV radiation at a dose of 1 J/cm² to manufacture a coating film. The coating film had a thickness of approximately 1 μm.

### Comparative Example 2

The low refractive-thermosetting material A was only used as a material for the formation of a coating layer, and applied to a triacetate cellulose film having a thickness of 80 μm using a wire bar (No. 5). The film was heat-cured in an oven at 120° C. for a day to manufacture a coating film. The coating film had a thickness of approximately 1 μm.

### Comparative Example 3

The low refractive-thermosetting material B was only used as a material for the formation of a coating layer, and applied to a triacetate cellulose film having a thickness of 80 μm using a wire bar (No. 5). The film was heat-cured in an oven at 120° C. for a day to manufacture a coating film. The coating film had a thickness of approximately 1 μm.

### Comparative Example 4

The high refractive-UV curable material F was only used as a material for the formation of a coating layer, and applied to a triacetate cellulose film having a thickness of 80 μm using a wire bar (No. 5). The film was dried in an oven at 120° C. for 2 min, cured by UV radiation at a dose of 200 mJ/cm², and left in the oven at 120° C. for a day. The coating film had a thickness of approximately 1 μm.

### Comparative Example 5

25 parts by weight of the low refractive-thermosetting material G, 70 parts by weight of the high refractive-UV curable material H, and 5 parts by weight of trifluoroethyl acrylate as a fluorinated compound were uniformly mixed to prepare a compatible coating composition for antireflection. A coating film was manufactured using the composition in the same manner as in Example 3.

### Comparative Example 6

25 parts by weight of the low refractive-thermosetting material G, 70 parts by weight of the high refractive-UV curable material H, and 5 parts by weight of the metal fluoride-dispersed liquid prepared in Example 10 were uniformly mixed to prepare a compatible coating composition for antireflection. A coating film was manufactured using the composition in the same manner as in Example 3.

### Experimental Example

The low and high refractive materials prepared in Preparative Example were used to manufacture cured products, and their refractive index and surface energy were measured, shown in Table 1. The methods for manufacturing the cured products using each material are as follows. The low refractive-thermosetting material was applied to a triacetate cellulose film having a thickness of 80 μm using a wire bar (No. 5), and left in an oven at 120° C. for a day. The high refractive-UV curable material was applied in the same manner as the low refractive material, except that it was dried in an oven at 60° C. for 2 min, and cured by UV radiation at a dose of 200 mJ/cm². The refractive index was measured using a prism coupler (Sairon Technology), and the surface energy was measured using Drop shape analysis system, DSA100 (KRUSS), and water and diiodomethane (CH₂I₂) as a standard.

TABLE 1

| | Low refractive | | | | | High refractive | | |
|---|---|---|---|---|---|---|---|---|
| | material | | | | | material | | |
| | A | B | C | D | E | F | G | H |
| Refractive | 1.39 | 1.39 | 1.39 | 1.41 | 1.44 | 1.51 | 1.51 | 1.50 |
| index | | | | | | | | |
| Surface | 14 | 12 | 12 | 19 | 28 | 40 | 40 | 32 |
| energy | | | | | | | | |
| (mN/m) | | | | | | | | |

The coating films manufactured by the methods of Examples and Comparative Examples had a thickness of 1 μm. The abrasion resistance and the optical characteristics including reflectance, transmittance, and haze of the antireflection films manufactured in Examples and Comparative Examples were evaluated as follows:

1) Evaluation of Scratch Resistance

Each coating film was scrubbed ten times using a steel wool (#0000) under the load of 1 kg, and then the scratch occurrence was evaluated.

2) Evaluation of Reflectance

The back side of the coating film was treated with black, and then reflectance was measured using a Solid Spec. 3700 spectrophotometer (Shimadzu) to determine the anti-reflection property depending on the minimum reflectance.

3) Evaluation of Transmittance and Haze

The transmittance and haze of the coating film were evaluated using HR-100 (Murakami, Japan).

The evaluation results of reflectance, transmittance, and haze are shown in the following Tables 2 and 3.

TABLE 2

| | Example No. | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Scratch | good | good | good | good | good | good | good | good | good | good | good | good | good |
| resistance | | | | | | | | | | | | | |
| Reflectance | 2.3 | 1.8 | 1.9 | 2.3 | 1.3 | 1.5 | 1.6 | 1.2 | 1.4 | 1.3 | 1.5 | 1.6 | 1.3 |
| (%) | | | | | | | | | | | | | |
| Transmittance | 95.4 | 95.7 | 95.5 | 95.3 | 96.7 | 96.4 | 96.5 | 96.7 | 96.6 | 96.7 | 96.4 | 96.5 | 96.6 |
| (%) | | | | | | | | | | | | | |
| Haze | 0.2 | 0.2 | 0.2 | 0.2 | 0.2 | 0.3 | 0.3 | 0.2 | 0.2 | 0.2 | 0.3 | 0.3 | 0.2 |
| (%) | | | | | | | | | | | | | |

TABLE 3

| | Comparative Example No. | | | | | |
|---|---|---|---|---|---|---|
| | 1 | 2 | 3 | 4 | 5 | 6 |
| Scratch | good | Scratch | Scratch | good | good | good |
| resistance | | | | | | |
| Reflectance | 3.8 | 2.1 | 1.5 | 3.8 | 3.9 | 3.9 |
| (%) | | | | | | |
| Transmittance | 94.2 | 95.8 | 95.9 | 94.2 | 94.1 | 94.1 |
| (%) | | | | | | |
| Haze (%) | 0.3 | 0.2 | 0.2 | 0.3 | 0.3 | 0.3 |

As shown in Tables 2 and 3, the coating films manufactured in Examples 1 to 14 exhibited good scratch resistance to have excellent abrasion resistance, as well as excellent optical characteristics including reflectance, transmittance, and haze. Meanwhile, the coating films manufactured in Comparative Examples 1 and 4 to 6 exhibited poor optical characteristics including transmittance or haze, as compared to those of Examples. Since the coating films manufactured in Comparative Examples 2 and 3 exhibited poor scratch resistance, an additional hard coating process is required. Therefore, there is a problem in that process efficiency is reduced.

In accordance with Examples and Comparative Examples, the antireflection film according to the present invention can be manufactured by one coating process, thereby improving process efficiency and reducing manufacturing cost, as well as achieving excellent antireflection characteristic and abrasion resistance.

The present invention has been described in connection with the preferred embodiments, although specific terms are employed herein, the scope of the present invention is not limited to the specific embodiments but should be construed on the basis of the appended claims.

1. A coating composition for antireflection that includes a low refractive material having a refractive index of 1.2 to 1.45 and a high refractive resin having a refractive index of 1.46 to 2, wherein the difference in the surface energy between two materials is 5 mN/m or more.

2. The coating composition for antireflection according to claim 1, wherein the low refractive material has a surface energy of 25 mN/m or less.

3. The coating composition for antireflection according to claim 1, wherein the low refractive material is a thermosetting resin and the high refractive material is a UV curable resin.

4. The coating composition for antireflection according to claim 3, wherein the low refractive material includes one or more selected from the group consisting of an alkoxysilane reactant causing a sol-gel reaction, a urethane reactive group compound, a urea reactive group compound, and an esterification reactant.

5. The coating composition for antireflection according to claim 3, wherein the high refractive material includes an acrylate resin, a photoinitiator, and a solvent.

6. The coating composition for antireflection according to claim 1, wherein the high refractive material is contained in an amount of 10 to 90 parts by weight and the low refractive material is contained in an amount of 5 to 80 parts by weight, based on 100 parts by weight of the total coating composition.

7. The coating composition for antireflection according to claim 1, wherein the difference in the refractive indices of the cured products of the low and high refractive materials is 0.01 or more.

8. The coating composition for antireflection according to claim 1, wherein the coating composition for antireflection further includes at least one of a fluorinated compound and a nanoparticle-dispersed liquid.

9. The coating composition for antireflection according to claim 8, wherein the fluorinated compound has a refractive index of 1.5 or less, a molecular weight being smaller than that of the low refractive material, and a surface energy between those of high and low refractive materials.

10. The coating composition for antireflection according to claim 8, wherein the nanoparticle-dispersed liquid includes nanoparticles having an average particle size of 1,000 nm or less.

11. The coating composition for antireflection according to claim 8, wherein the nanoparticle-dispersed liquid has a refractive index of 1.45 or less.

12. The coating composition for antireflection according to claim 10, wherein the nanoparticle-dispersed liquid further includes a dispersion-enhancing chelating agent, fluorinated acrylate and a solvent.

13. The coating composition for antireflection according to claim 10, wherein the nanoparticle is metal fluoride or organic/inorganic hollow or porous particle.

14. A method of manufacturing an antireflection film, comprising the steps of:
a) preparing the coating composition for antireflection according to claim 1;
b) applying the coating composition on a substrate to form a coating layer;
c) drying the coating layer to allow phase separation of low and high refractive materials; and d) curing the dried coating layer.

15. The method of manufacturing an antireflection film according to claim 14, wherein in step b), the dried coating thickness is 1 to 30 μm.

16. The method of manufacturing an antireflection film according to claim 14, wherein the low refractive material is a thermosetting resin and the high refractive material is a UV curable resin, and step d) comprises the steps of d1) curing the high refractive-UV curable resin by UV radiation at a dose of 0.1 to 2 J/cnf for 1 to 600 sec and d2) curing the low refractive-thermosetting resin at a temperature of 20 to 200° C. for 1 to 72 hrs.

17. An antireflection film manufactured by using the coating composition for antireflection according to claim 1, wherein the antireflection film includes a single coating layer in which the low and high refractive materials have a concentration gradient in a thickness direction.

18. The antireflection film according to claim 17, wherein the antireflection film is manufactured by a method including:
a) preparing a coating composition for antireflection that contains a low refractive resin having a refractive index of 1.2 to 1.45, a high refractive material having a refractive index of 1.46 to 2, and the difference in the surface energy between two materials is 5 mN/m or more;
b) applying the coating composition on a substrate to form a coating layer;
c) drying the coating layer to allow phase separation of the low and high refractive materials; and
d) curing the dried coating layer.

19. The antireflection film according to claim 17, wherein the low refractive material, which is included in a region corresponding to in a thickness direction from the surface of the single coating layer facing air, is 70% or more, based on the total weight of the low refractive material.

20. The antireflection film according to claim 17, wherein reflectance is lower than 3%.

21. A polarizing plate comprising: a) a polarizing film; and b) the antireflection film of claim 17.

22. A display device comprising the antireflection film according to claim 17.
